(19) United States
(12) Patent Application Publication
(10) Pub. No.: US 2015/0186443 A1
(43) Pub. Date: Jul. 2, 2015

(54) MANAGEMENT OF VERSIONED MAP DATA TILES STORED ON A CLIENT DEVICE

(71) Applicants: Keith Ito, Cambridge, MA (US); Ronghui Zhu, Sunnyvale, CA (US); Thomas G. Nourse, Half Moon Bay, CA (US)

(72) Inventors: Keith Ito, Cambridge, MA (US); Ronghui Zhu, Sunnyvale, CA (US); Thomas G. Nourse, Half Moon Bay, CA (US)

(73) Assignee: GOOGLE INC., Mountain View, CA (US)

(21) Appl. No.: 13/297,956

(22) Filed: Nov. 16, 2011

(51) Int. Cl. G06F 17/30; G06F 3/048

(52) U.S. Cl. CPC G06F 17/30356; G06F 17/30867; G06F 17/30241; G06F 3/048

(57) ABSTRACT

A pre-fetching map data system and method identifies a subset of map data to corresponding to one or more points of interest to be displayed on the map. The map data is stored on a remote map database and in the form of map data tiles bearing version numbers. The pre-fetching map data system identifying those map data tiles that correspond to the subset of map data corresponding to the one or more points of interest, where the identified pre-fetch map data tiles are sent from the remote database to a client device for storing the pre-fetch map data tiles. During pre-fetching the version number of the received map data tiles is examined to determine if a version update for additional map data tiles should be scheduled and executed to update out of date map data on the client device.

### FIELD OF TECHNOLOGY

The present disclosure relates to map data optimization and more specifically to a system and a method to pre-fetch map data from a remote map database.

### BACKGROUND

With the widespread use of mobile devices, such as mobile phones, personal data assistants, tablet personal computers, etc., consumer demand for ready access to varied types of data continues to grow at a high rate. These devices are used to transmit, receive, and store text, voice, image, and video data. Consumers often look to store large numbers of applications on these devices, such that mobile devices are often touted more for the number of available applications, than internal processor speed. While consumers have come to desire fast access to data, the sheer amount of data required to run these applications places a premium on data management, both at the device level and at the network level. This premium limits the effectiveness of applications such as mapping applications, which typically require comparatively large amounts of network data.

Mapping applications are found in a variety of mobile devices, including car navigation systems, hand-held GPS units, mobile phones, and portable computers. These applications are among the most frequently used applications and are considered, by some, necessary for personal safety. Although the underlying digital maps are easy to use from a user's perspective, creating a digital map is a data intensive process. Every digital map begins with a set of raw data corresponding to millions of streets and intersections. That raw map data is derived from a variety of sources, each providing different amounts and types of information. To effectively map a location, locate a driving route between a source and a destination, identify points of interest, etc. requires substantial amounts of data. Furthermore, many mapping applications require display of different map data at different zoom levels, i.e., different scales, where the amount of detail and that nature of that detail changes at each zoom level. For example, at a lowest zoom level, scaled farthest away from a target, the map data may contain the boundaries of continents, oceans, and major landmasses. At subsequent zoom levels, that map data may identify countries, states, homelands, protectorates, and other major geographic regions. While at even further subsequent zoom levels, that map data may contain major roads, cities, towns, until eventually the map data contains minor roads, buildings, down to even sidewalks and walk ways depending on the region. The amount of detail is determined by the sources of information used to construct the map data at each zoom level. But no matter the zoom level, the amount of information is voluminous and generally too large for storage, in total, on mobile devices and too large for continuous download over a wireless communication network.

In operation, mapping applications typically download map data to the mobile device through a wireless communication network and in response to a user entering a location of interest and/or based on the current location of the mobile device, such as the current global positioning satellite (GPS) data or current cellular network location data for the device. A conventional technique for downloading map data is to have the mobile device communicate this location data to a remote processor on the wireless communication network, which, in response, downloads all map data to the mobile device or the map data requested for display to the user.

Generally speaking, the map data is stored in blocks known as map data tiles, where the number of map data tiles increases with zoom level. The remote processor provides a subset of the available map data tiles for a particular location or region to the mobile device for storage and display at any particular time via a map display application. By providing large numbers of map data tiles, the mobile device may buffer the map data for display to the consumer as the consumer scrolls across an area using the mapping application looking for adjacent or other mapping locations. However, the larger the number of map tiles provided at any particular time increases the download time and buffer memory usage while the user is using the map display application.

Conventionally, map data tiles are downloaded and cached, but in a crude manner that is unable to take advantage of memory surpluses on devices and unable to take advantage of network bandwidth surpluses, e.g., when the user is not using the device. The conventional techniques are similarly deficient in the face of lacking memory and reduced bandwidth. As a result, there is a need to have more intelligent mechanisms for downloading map data, in particular map data tiles, to sufficiently satisfy the needs of the user, while doing so in a manner that addresses network bandwidth and memory conditions.

### SUMMARY

In accordance with an embodiment, a computer-implemented method comprises: identifying, on a client device, one or more map points of interest; identifying, based on the map points of interest, pre-fetch map data tiles to be requested from a remote map database and stored on the client device for eventual rendering of a visual display of map data in response to a subsequent user request; requesting, from a remote map database storing the map data, the pre-fetch map data tiles corresponding to one or more map points of interest; receiving, at the client device, the pre-fetch map data tiles from the remote map database; determining, at the client device, if any of the received pre-fetch map data tiles has a map data version number newer than a map data version number for one or more map data tiles stored on the client device, where if a newer version number is determined, a map data tile version update is scheduled for the client device; and storing the received pre-fetch map data tiles in a local memory on the client device until a subsequent user request.

In accordance with another embodiment, a computer-readable medium storing instructions, the instructions when executed by a processor cause the processor to: identify, on a client device, one or more map points of interest; identify, based on the map points of interest, pre-fetch map data tiles to be requested from a remote map database and stored on the client device for eventual rendering of a visual display of map data in response to a subsequent user request; request, from a remote map database storing the map data, the pre-fetch map data tiles corresponding to one or more map points of interest; receive, at the client device, the pre-fetch map data tiles from the remote map database; determine, at the client device, if any of the received pre-fetch map data tiles has a map data version number newer than a map data version number for one or more map data tiles stored on the client device, where if a newer version number is determined, a map data tile version update is scheduled for the client device; and store the received pre-fetch map data tiles in a local memory on the client device until a subsequent user request

In accordance with yet another embodiment, a computer system for fetching map tile data to be used in rendering a visual display of map data on a client device, the computer system comprises: a display module for constructing and displaying the visual display of the map data, where the map data is stored in a remote map database as a plurality of map data tiles; a map point identifier module that identifies one or more map points of interest that define pre-fetch map data tiles to be requested from a remote map database and stored on the client device for eventual rendering of a visual display of map data in response to a subsequent user request; a database interface module to request, from the map database, the pre-fetch map data tiles from the remote map database and to receive the pre-fetch map data tiles from the remote map database; and a map tile version updater module that in response to receiving the pre-fetch map data tiles, determines at the client device, if any of the received pre-fetch map data tiles has a map data version number newer than a map data version number for one or more map data tiles stored on the client device, where if a newer version number is determined, the map tile version updater module schedules a map data tile version update.

In accordance with a further embodiment, a computer-implemented method for fetching map tile data to be used in rendering a visual display of map data on a client device, the method comprises: sending, from the client device, a polling request to a remote map database storing the map data, the polling request identifying one or more map data tiles stored in the map database; receiving, at the client device, responsive map data containing a version number for each of the identified map data tiles stored in the map database; and in response to analysis of the responsive map data, determining if map data tiles stored on the client device are to be updated, and if the map data tiles stored on the client are to be updated, identifying map data tiles that are to be updated, and requesting updated map data tiles from the remote map database for the identified map data tiles.

In accordance with yet another embodiment, a computer-readable medium storing instructions, the instructions when executed by a processor cause the processor to: send, from the client device, a polling request to a remote map database storing map data, the polling request identifying one or more map data tiles stored in the map database; receive, at the client device, responsive map data containing a version number for each of the identified map data tiles stored in the map database; and in response to analysis of the responsive map data, determine if map data tiles stored on the client device are to be updated, and if the map data tiles stored on the client are to be updated, identify map data tiles that are to be updated, and request updated map data tiles from the remote map database for the identified map data tiles.

In another embodiment, a computer system for fetching map tile data to be used in rendering a visual display of map data on a client device, the computer system comprises: a display module for constructing and displaying the visual display of the map data, where the map data is stored in a remote map database as a plurality of map data tiles; a map point identifier module that identifies one or more map points of interest that define pre-fetch map data tiles to be requested from a remote map database and stored on the client device for eventual rendering of a visual display of map data in response to a subsequent user request; a database interface module to request, from the map database, the pre-fetch map data tiles from the remote map database and to receive the pre-fetch map data tiles from the remote map database; and a map tile version updater module that, instructs the client device to send a polling request to the remote map database storing the map data, the polling request identifying one or more map data tiles stored in the map database, receives responsive map data containing a version number for each of the identified map data tiles stored in the map database, and analyzes the responsive map data to determine if map data tiles stored on the client are to be updated, and if the map data tiles stored on the client are to be updated, the client device identifies map data tiles that are to be updated and requests updated map data tiles from the remote map database for the identified map data tiles.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is high-level block diagram of a wireless network depicting a wireless base station connected to a server containing map data for selectively communicating that map data to a various client devices on the network.

FIG. 2 is a block diagram of an example map generator in the client device of FIG. 1.

FIG. 3 illustrates a portion of the data structure for the map database of FIG. 1.

FIGS. 4A, 4B, and 4C illustrate example renditions of map data at three different zoom levels, respectively.

FIG. 5 illustrates an example process or flow diagram for performing a pre-fetching of map data tiles and performing a tile version interrupt procedure during pre-fetching.

FIGS. 6A, 6B, and 6C illustrate example renditions of the map data of FIGS. 4A, 4B, and 4C, at three different zoom levels, respectively, and showing points of interest at the different zoom levels.

FIG. 7 illustrates an example process or flow diagram for constructing and displaying pre-fetch map data visually.

FIG. 8 illustrates an example process or flow diagram for determining points of interest to be used in identifying the pre-fetch map data.

FIG. 9 illustrates an example process or flow diagram for identifying the pre-fetch map data in response to the identified points of interest, zoom levels, and tile radii.

FIG. 10 illustrates an example process or flow diagram for determining whether a map data tile version update is needed and which may be performed during the pre-fetching of FIG. 5.

FIG. 11 illustrates another example process or flow diagram for determining whether a map data tile version update is needed and which may be performed after a pre-fetching process has occurred.

FIG. 12 illustrates an example process or flow diagram for constructing and displaying a visual map prior to updating displayed map data.

### DETAILED DESCRIPTION

The present application describes techniques for fetching map data over a selected subset of the entire map data available, by identifying one or more points of interest for display on client device. The techniques, which may be implemented on a client device such as a mobile or handheld device, will access map data pertaining to these points of interest from a remote server. In this way, the techniques do not need to access an entire map database, but rather only a portion thereof. The map data is stored at the remote server in the form of map data tiles each characterized by a tile version. These map tiles are, at times, individually updated to newer versions. The techniques therefore monitor for pre-fetch map data tiles that are bear newer versions than existing pre-fetch map data tiles. When newer tile versions are found, the techniques can then request receipt of other map data tiles corresponding to the newer, most recently download tile version.

More particularly, the present application describes techniques for fetching map data over a selected subset of the entire map data available, by identifying one or more points of interest for display on client device, where those points of interest are identified by the user of the client device, for example by the user searching for a particular location or direction between locations through a mapping application on the client device. In other embodiments, the points of interest are automatically determined by the client device, for example by the client device identifying a set of most recently accessed points of interest or a set of most frequency accessed points of interest. In either case, the points of interest are identified to a remote server that contains a map database of the entire map data, including map data for the points of interest. With the points of interest identified, the remote server begins transmitting the map data, corresponding to these points of interest, to the client device for storage and display to the user. Storing map data in data blocks known as map data “tiles,” the remote server sends the map data in the form of a map data tiles. For each point of interest, the server may send an identified set of map data tiles, termed pre-fetch map data tiles. The client device receives the pre-fetch map data tiles under a normal schedule. During receipt, the client device determines if any of the received map data tiles bear a newer version number compared to map data tiles already stored on the device. If a newer version map data tile is found, the client device then schedules a map data tile update, which typically would occur after the pre-fetching procedure has completed, but which in other examples can interrupt and modify an executing pre-fetching procedure. In some embodiments, the client device will automatically and periodically poll the remote server to determine if updated map data tiles are stored on the server, in response to which the client device will request download of the updated map data tiles corresponding to the map data tiles stored on the client device.

Pre-fetching refers to requesting map data from a remote map database, such as that of a remote server, prior to any specific user request for map data, so that map data may be collected and buffered on a device until a specific user request for map data. In this way, pre-fetching seeks to collect map data in the background, before that map data is called upon to construct a visual display, thereby reducing (and even eliminating) the need for a client device to request map data only after a user request. The pre-fetched map data is automatically identified, requested, and stored on the client device for subsequent use in constructing a visual display. As discussed in examples below, where that map data is stored in the remote map database in the form of map data tiles, the pre-fetching is of map data tiles.

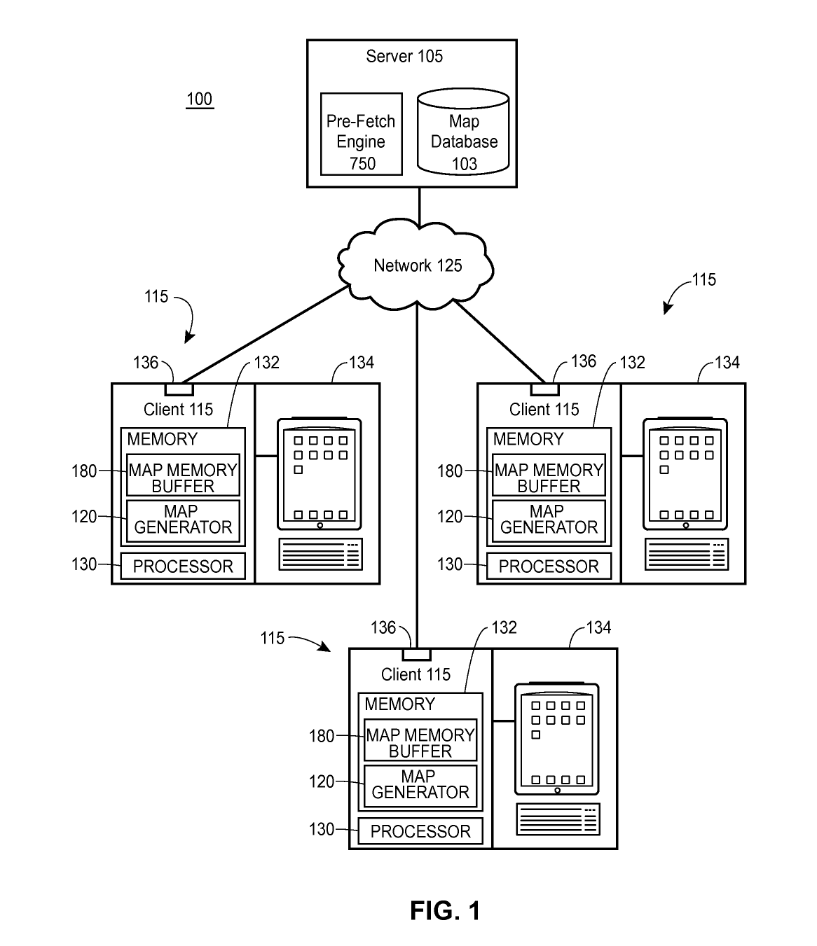

FIG. 1 is a high-level block diagram that illustrates a computing environment for a pre-fetch map data system 100 that may be used to access and store map data within a map database. As illustrated in FIG. 1, the computing environment includes a map database 103 connected to or disposed within a server 105, which is, in turn, connected to a number of client devices 115 through a network 125. The network 125 includes but is not limited to any combination of a LAN, a MAN, a WAN, a mobile, a wired or wireless network, a private network, or a virtual private network. While only three clients 115 are illustrated in FIG. 1 to simplify and clarify the description, it is understood that any number of client computers are supported and can be in communication with the server 105.

Both the server 105 and the clients 115 are computers that may include a CPU 130 (only shown in the clients), one or more computer readable memories 132, one or more user interfaces 134 (keyboard, touch screen, etc.), a network interface 136, one or more peripheral interfaces, and other well known components. As is known to one skilled in the art, other types of computers can be used that have different architectures. The client devices 115 represent any suitable handheld and/or mobile device, such as a mobile phone, personal data assistant, laptop computer, tablet personal computer, car navigation system, hand-held GPS unit, or “smart” device. More broadly, the client devices 115 represent any personal computing device, database, server, or network of such devices, or any other processing device having a user interface and CPU and capable of displaying a visual rendition of map data accessed from the map database 103 or other remote source of map data. Furthermore, while in some examples, the network 125 is described as a wireless network, the network 125 may be any wired or wireless network, where the clients 115 are devices on the network.

The server 105 and the clients 115 are also adapted to execute computer program modules for providing functionality described herein. As used herein, the terms “module” and “routine” refer to computer program logic used to provide the specified functionality. Thus, a module or a routine can be implemented in hardware, firmware, and/or software. In one embodiment, program modules and routines are stored on a storage device, loaded into memory, and executed by a processor or can be provided from computer program products that are stored in tangible computer-readable storage mediums (e.g., RAM, hard disk, optical/magnetic media, etc.).

The map database 103, which may be stored in or may be separate from the server 105, contains map data that can be used to generate a digital map or that can be used by, for example, a navigation system to determine routes between two locations. Physical roads, waterways, parks, landmarks, and other geographic elements may be represented in the map data by a list of nodes and segments that connect those nodes. Each node corresponds to a specific geographic location in the physical world. The data representation for each node generally includes a set of coordinates (e.g., latitude and longitude) and an association with one or more segments. For roads, each segment corresponds to a section of a physical location that begins at one node and ends at a different node. The data representation for each road segment, for example, can include a length and a number of attributes, such as a street name, a priority (e.g., a highway or a local road), speed information, a surface type, a road width, an indication of whether the road segment is a one-way segment, address ranges, usage (e.g., ramp or trail), etc.

The map data stored in the map database 103 can be obtained from several different sources such as the New York City Open Accessible Space Information System (OASIS) and the U.S. Census Bureau Topologically Integrated Geographic Encoding and Referencing system (TIGER). The map data can also be accessed by one of the map generators 120, modified, and stored back into the database 103. Further, the database 103 does not need to be physically located within server 105. For example, the database 103 can be partially stored within a client 115, can be stored in external storage attached to the server 105, or can be stored in a network attached storage. Additionally, there may be multiple servers 105 that connect to a single database 103. Likewise, the map database 103 may be stored in multiple different or separate physical data storage devices.

Each client 115 executes one of the map generators 120, each of which receives pre-fetch map data from the server 105 and generates a visual display of the received map data that is presented to the user on a display of the interface 134. The map generator 120 is able to adjust that visual display in response to user interactions with the interface 134, for example, adjusting which map data is visualized at any given time in response to a user selecting to scroll (left, right, up, down, etc.) through the visual display, or in response to the user selecting to change the zoom level (e.g., scale) of the displayed map data.

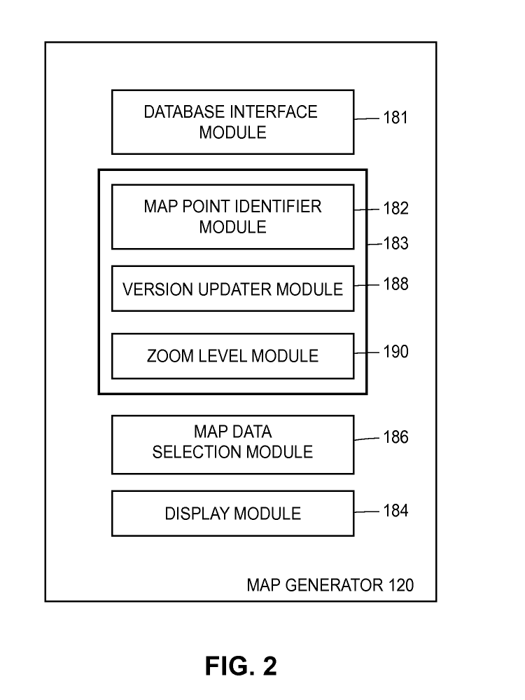

As illustrated in the detailed example of FIG. 2, the client 115 may include various modules within or associated with the map generator 120, including a database interface module 181 that operates to retrieve map data from the server 105 and map database 103. The map generator 120 further includes a pre-fetching module 183 that, in the illustrated embodiment, includes a map point identifier module 182 capable of identifying one or more points of interest that are to be used by a display module 184 to create a visual map display of received map data on the interface 134. The points of interest are communicated by the interface module 181 through the network interface 136 through network 125 to the server 105, which responds by sending pre-fetch map data from the map database 103 back to the client device 115, where this pre-fetch map data is received by the database interface module 181 and is stored in a map buffer memory 180 of the client 115. A map data selection module 186 accesses the stored pre-fetch map data and determines which portion of that buffered map data is to be provided to the display module 184 for creating the visual map display on the interface 134. The module 186, therefore, is responsive (after pre-fetching) to user interaction with the interface 134 to determine which portion of the pre-fetched map data should be displayed to the desires in response to a subsequent user interaction, which is determined by a centralized map position, user scrolling, and zoom level, for example.

In some embodiments, the pre-fetching module 183 includes a zoom level module 190 that identifies the zoom levels for the pre-fetch map data tiles requested from the remote server 105 by the interface module 181. The interface module 181 receives the pre-fetch map data tiles from the server 105 and stores them in the buffer memory 180 for eventual display using the map data selector module 186 and the display module 184.

While not shown, in some embodiments the pre-fetching module 183 includes modules for defining other characteristics or limitations on pre-fetching map data tiles, other than points of interest and zoom level. For example, the pre-fetching module 183 may include a tile radius module, as described in co-pending application U.S. application Ser. No. 13/297,720, entitled “Pre-Fetching Map Data Using Variable Map Tile Radius,” filed on Nov. 16, 2011, the specification of which is incorporated herein by reference, in its entirety.

In the illustrated embodiment, the pre-fetching module 183 further includes a tile version updater module 188 that determines when updated map data tiles are available for pre-fetching to the client device 115 or otherwise needed at the client device 115 and which then schedules to download a complete or otherwise updated set of map data tiles. The client 115, for example, receives map data tiles at the database interface module 181, where upon receipt of one or any predetermined number of map data tiles, the version updater module 188 determines if the received map data tiles are a newer version than the map data tile stored on the device.

While the version updater module 188 is described as contained within the map generator 120, in other examples, a version updater module may be stored in the server 105 or in both the client 115 and the server 105. The version updater module 188, for example, may be implemented in the map generator 120 of the client 115 or implemented as a standalone or integrated module at the server 105.

Of course, some embodiments of the map generator 120 may have different and/or other modules than the ones described herein. Similarly, the functions described herein can be distributed among the modules in accordance with other embodiments in a different manner than that described herein.

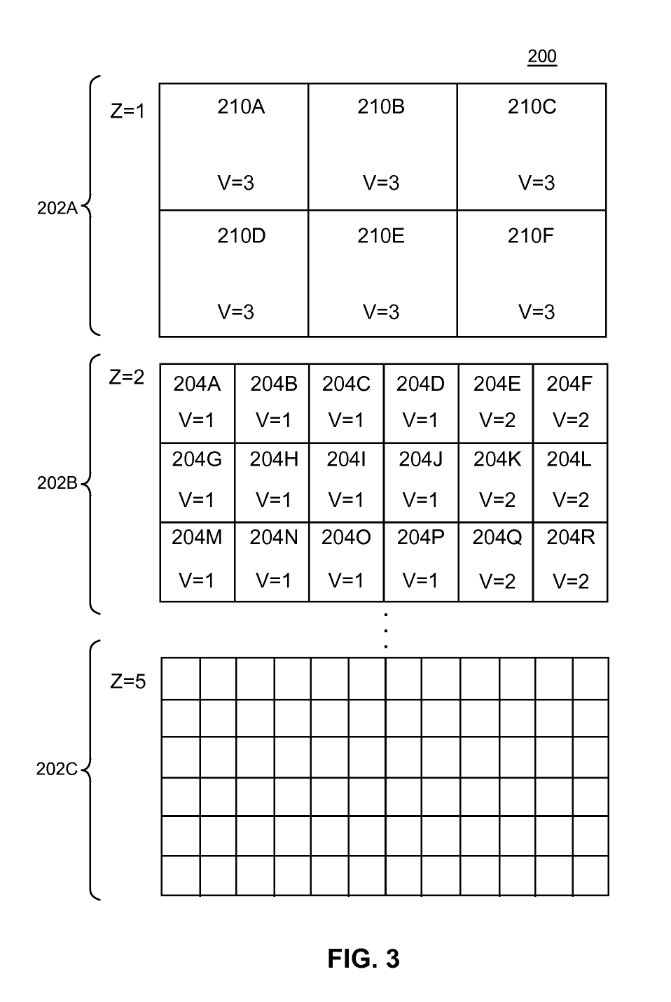

Generally speaking, map data in the map database 103 is stored in different zoom levels each formed of a plurality of map data blocks, termed map tiles, which are used to construct a visual display of the map. FIG. 3 illustrates an example data structure 200 of a portion of the map database 103. The map data is stored in numerous (n) different zoom level data structures (only three of which are shown) 202A, 202B, and 202C, where each data structure is formed by a plurality of map data tiles. The data structure 202B, shows the map data at zoom level, z=2, is formed of 18 map data tiles, 204A-204R. The map tiles represent the basic building blocks for constructing a map display. Each map tile contains necessary map data to construct a portion of the map display, including data identifying roads, buildings, and geographic boundaries, such as water lines, county lines, city boundaries, state lines, mountains, parks, etc. The map data may be stored in any number of different zoom level data structures. In an embodiment, 19 total zoom levels are stored in the map database 103.

The number of tiles at each zoom level increases, e.g., linearly, quadratically, exponentially, or otherwise. The zoom levels in the illustrated example (z=1, 2, and 5) have 6, 18, and 60 map data tiles, respectively, covering the same geographic area or region. While the data structure 200 is discussed in terms of the map database 103, it will be appreciated that, in some examples, a like data structure is used to store map data tiles on the client device 115.

In some embodiments, each map tile contains map data stored in a bitmap format, for display to the user using a raster display engine executed by the display module 184. In other embodiments, the map tile may contain map data stored in vector format, for display using a vector buildup display engine executed by the display module 184. In either case, the display module 184 may employ a C++, HTML, XML, JAVA, or Visual Basic application for generating a visual display of the map tiles.

In the illustrated embodiment, all map data is stored in map tiles, and each map tile in a zoom level data structure is allocated the same memory allocation size. For example, each tile 204A-204R may be a bitmap image 10 Kbytes in size. This may be achieved, for example, by having each map tile cover the same sized geographic area. For map tiles containing vector data, the data size for each tile may vary, but each tile may still, in some embodiments, be allotted the same maximum memory space. Although not illustrated, in other embodiments, the data tiles will have different memory space allocations within a zoom level data structure.

The map data tiles are also characterized by version number, v=1, 2, . . . n, reflecting how recently the map data tile data has been updated. The map data 200 stored on the server 105 is updatable. The server 105 may update the map data 200 on a per tile basis, on a per zoom level data structure basis, over the entire map data 200, or over some combination thereof. These updates occur at the server 105, but may be initiated at the server 105, at the client 115, at a map data provider coupled to the server 105, or otherwise. In the illustrated example, some of the map data tiles have a v=1, indicating a first version of stored map data, while other map data tiles have a v=2, indicating a more recently updated set of map data tiles. While in some examples, an entire zoom level data structure (e.g., 202A-202C) may be updated, in the illustrated example, only a portion corresponding to the actual updated geographic data has been updated. As a result the geographic data for map data tiles 204E, 204F, 204K, 204L, 204Q, and 204R bear more recent versions than the other map data tiles in data structure 202B. It is further noted that some of the zoom data structures may have high version numbers than other zoom data structures. For illustration purposes, map tiles 210A-210F are all shown as bearing version number three, v=3, meaning that these map data tiles have been updated more frequently than those of data structure 202B.

It is noted that, at the server 105, the version number may simply reflect the number of times a particular map data tile has been updated not whether the map data tile contains the most recently map data. In most examples, it is presumed that no matter the version number, the map database 103 contains the most recent, corresponding geographic data.

It is further noted that even where map data tiles at different zoom level data structures correspond to the same geographic area, the respective data tiles at the different zoom levels may bear different version numbers. This may be the case, for example, where there have been changes to geographic data visible at a higher (i.e., more narrowly focused) zoom level that would not appear in the lower (i.e., less narrowly focused) zoom levels.

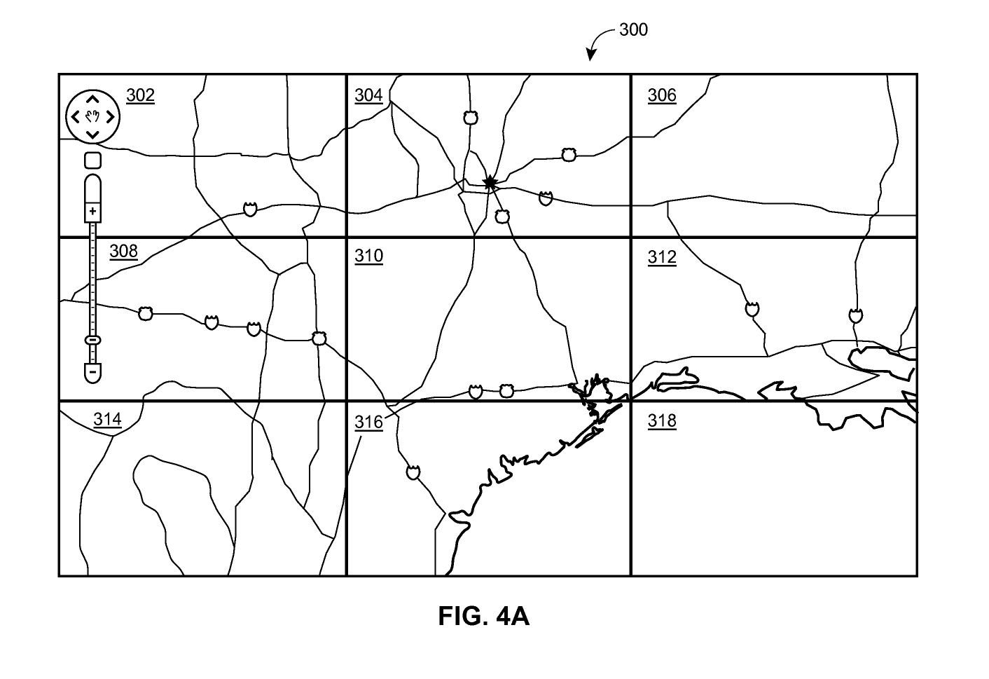

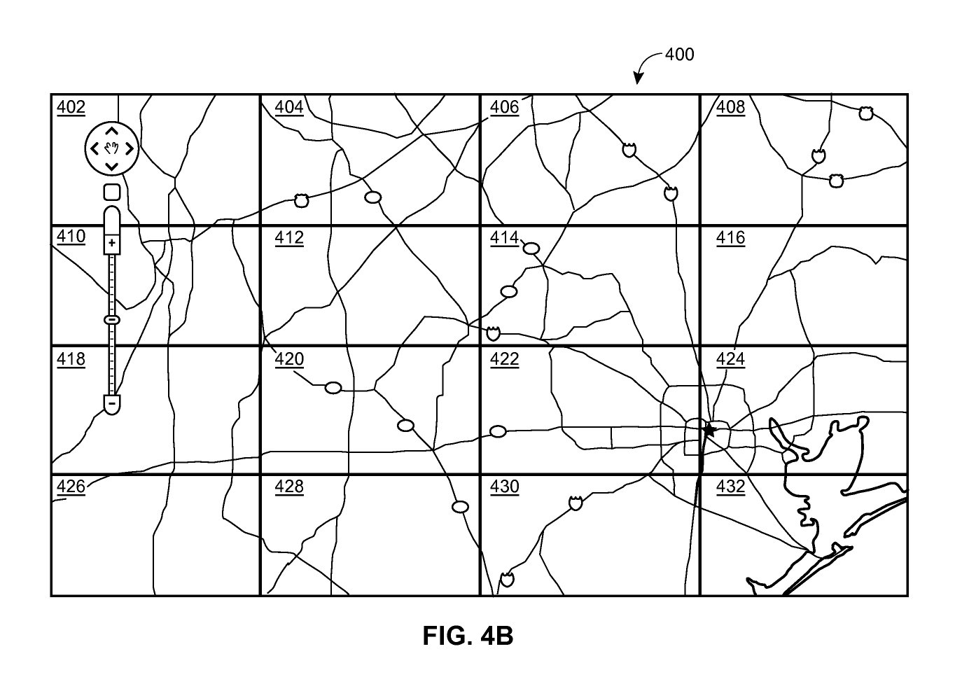

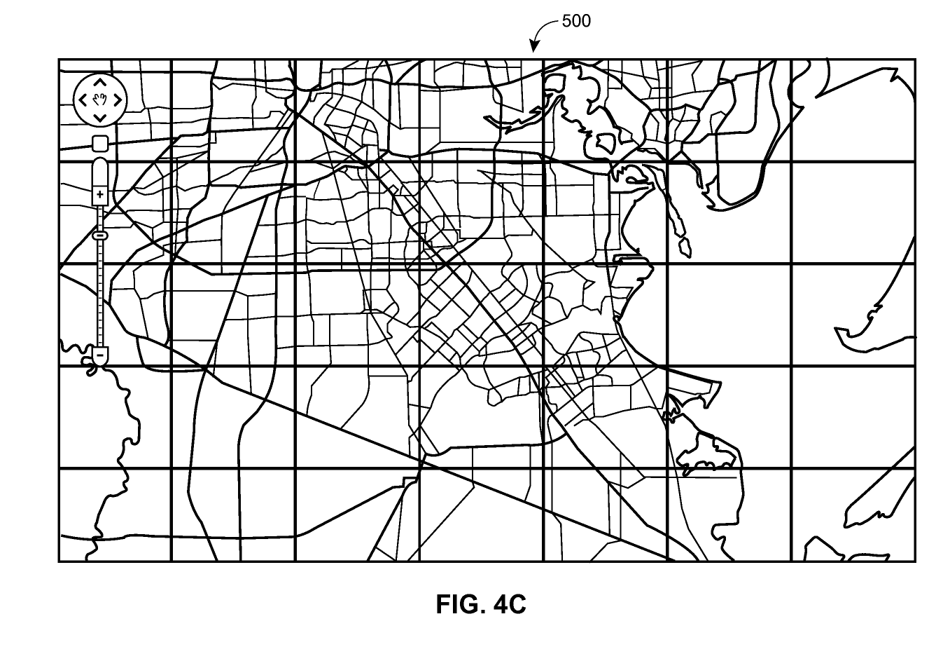

FIGS. 4A-4C illustrate visual map displays, e.g., that may be fully or partially displayed on the user interface 134, where each figure provides a visual display at a different zoom level. In the illustrated embodiments, FIG. 4A provides a visual map display 300 at an example zoom level, z=6, constructed of a series of map tiles 302-318, which cover the same size geographic area and which have the same amount of memory size.

In operation, the server 105 is able to transmit map data to respective clients 115 in chunks of data defined by these map tiles. For example, to transmit the map data needed to construct the map display 300, the server 105 may transmit each map tile in a frame, having a header portion providing identification data of the frame (such as geographic position, client device address, map tile version number, etc.) and a payload portion containing the specific map tile data to be used in forming the visual display. Map data tiles provide an effective mechanism for quantizing map data stored in the map database 103 and for quantizing communication of the map data over the network 125 to the clients 115.

In comparison to FIG. 4A, FIG. 4B illustrates a visual map display 400 at a zoom level higher than the zoom level of FIG. 4A, in this example zoom level, z=10. The map display 400 is formed of a plurality of map tiles 402-432. Like the map tiles 302-318, the map tiles 402-432 are each the same in size, e.g., covering the same geographic area and having the same memory size. FIG. 4C illustrates another visual map display 500 at a third even higher zoom level, zoom level z=12, formed of map data tiles.

Each of the displays 300, 400, and 500 is of a portion of the overall map data, which comprises many more map data tiles.

As illustrated across FIGS. 4A-4C, the map tiles that form each visual map display have various levels of detail. The tiles 302-318 illustrate geographic boundaries, but no roads, only highways and/or interstates, while the tiles of FIG. 4C are at a higher zoom level and contain information on roads, buildings, parks, end points, etc.

As the zoom levels increase, i.e., as the visual map display focuses down on a smaller geographic region, the amount of map data may reach a maximum point, beyond which all zoom levels will contain the same map data. The number of map tiles needed to construct a map display may vary but the total amount of map data becomes saturated. The zoom level corresponding to this point is termed the saturation zoom level and represents the zoom level at which all roads, building, parks, end points, and other map data elements for a geographic region are provided. Any additional zoom levels selected by the user merely zoom in further on these map data elements. In the illustrated example of FIGS. 4A-4C, zoom level, z=12, represents the saturation zoom level.

While a user interacts with the visual map displays 300, 400, and 500, the user may wish to scroll around to display other map data near the illustrated map data. Therefore, the client device 115 uses a system to fetch and store a sufficient amount of map data to form the visual map display while buffering additional map data at the local device 115 to allow efficient user interaction with that display.

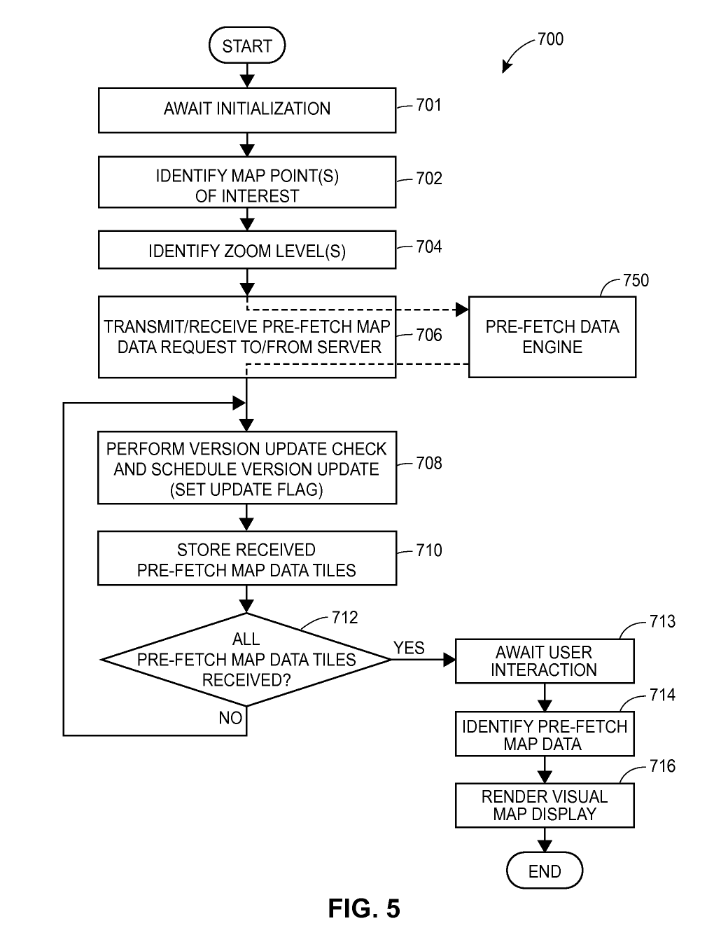

FIG. 5 illustrates a routine or process 700 for requesting and receiving map data tiles from a remote server. At a block 701, the routine or process 700 awaits initiation, which may result from user action, such as a user activating a mapping application on the client device 115. Initiation may also result from user or application initiated searches, direction end points, and stored location accesses by a user or application. In some embodiments, the block 701 functions to automatically initiate the routine or process 700, for example, by periodically initiating pre-fetching map data. For example, the block 701 may be designed to initiate the process every hour, every day, a few times a day, or at any other suitable periodic interval. In some embodiments, that automatic initiation can occur in response to an event unbeknownst to the user of the client device, such as when mobile wireless services are initially activated on the client device or when the client device enters entirely new geographic region, such as when a user has traveled to a city location.

At a block 702, the map point identification module 182 automatically (i.e., without user interaction or initiation) determines one or more map points of interest to display to a user via the interface 134. The module 182 may automatically identify points of interest, for example, by determining a GPS position of the current location of the client 115, by determining most recently searched points of interest, by accessing a database of stored points of interest, or by determining the most recently visited points of interest (e.g., cities, neighborhoods, etc.). Of course, in some of these cases, the module 182 may determine locations for which to download map data for storage at the user device as a background application and thus without any particular user interaction. An example further implementation of the module 182 and the block 702 is described in the routine or process of FIG. 8.

In other examples, the module 182 may manually determine the points of interest based on previous user input, for example, through the user providing an address into a data field presented on the interface 134, or through the user selecting to find a point of interest obtained through interaction with the interface 134 more generally. For example, the user can access a web-browser or other program running on the client device that identifies a location, business, home, etc., from which the module 182 may allow the user to select such item for building a map display of the vicinity around such point of interest. Any suitable manual method for entering or otherwise identifying one or more points of interest may be used by module 182 and collected by the block 702. Further still, these manual methods can be modified into automatic methods of map point identification, by having the block 702 access historical data on previous, manual user data inputs.

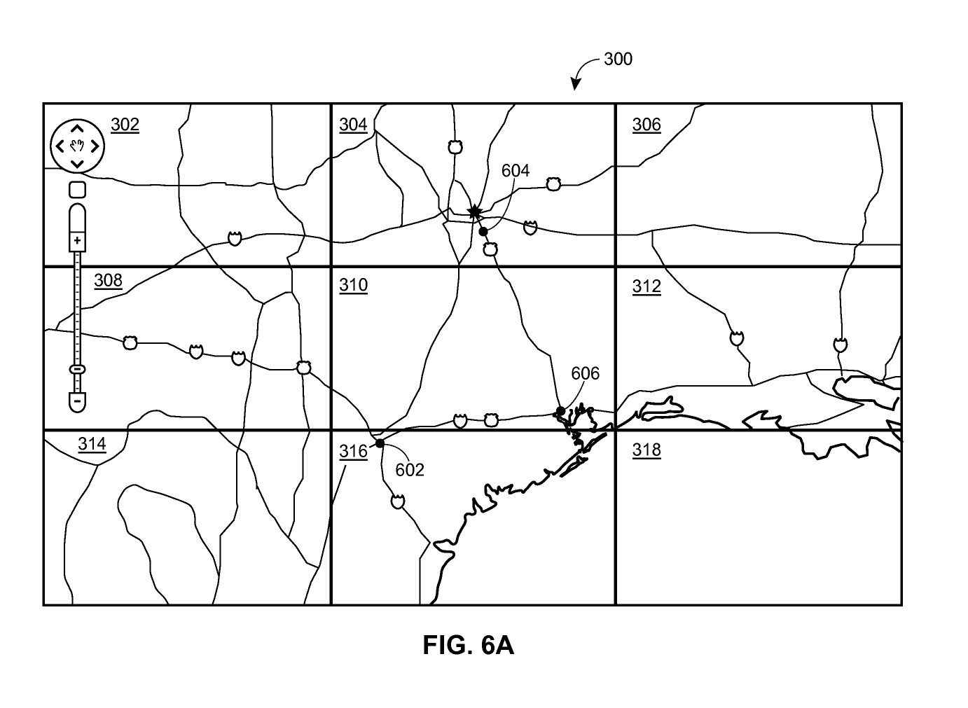

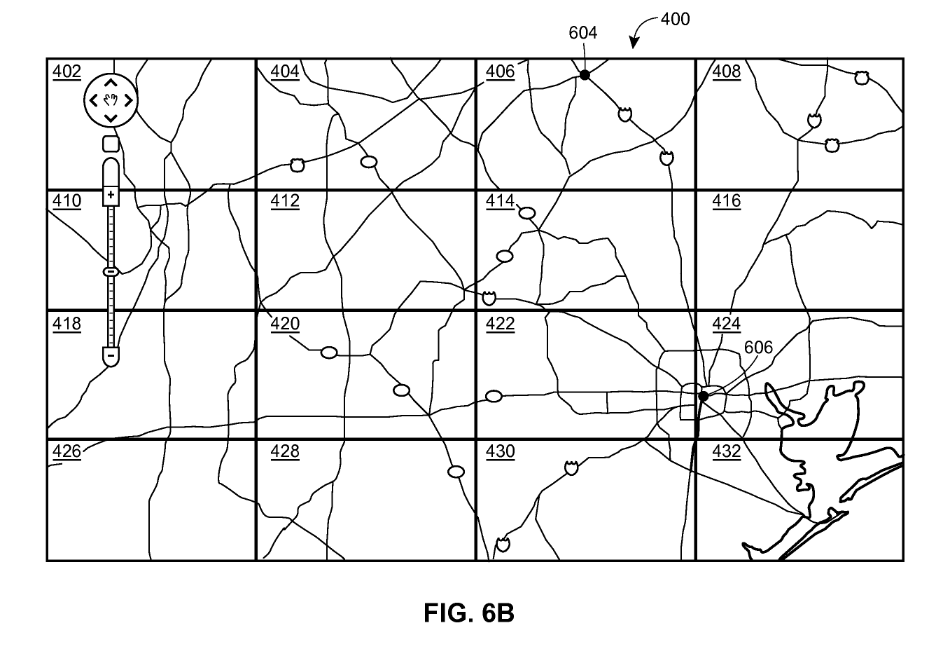

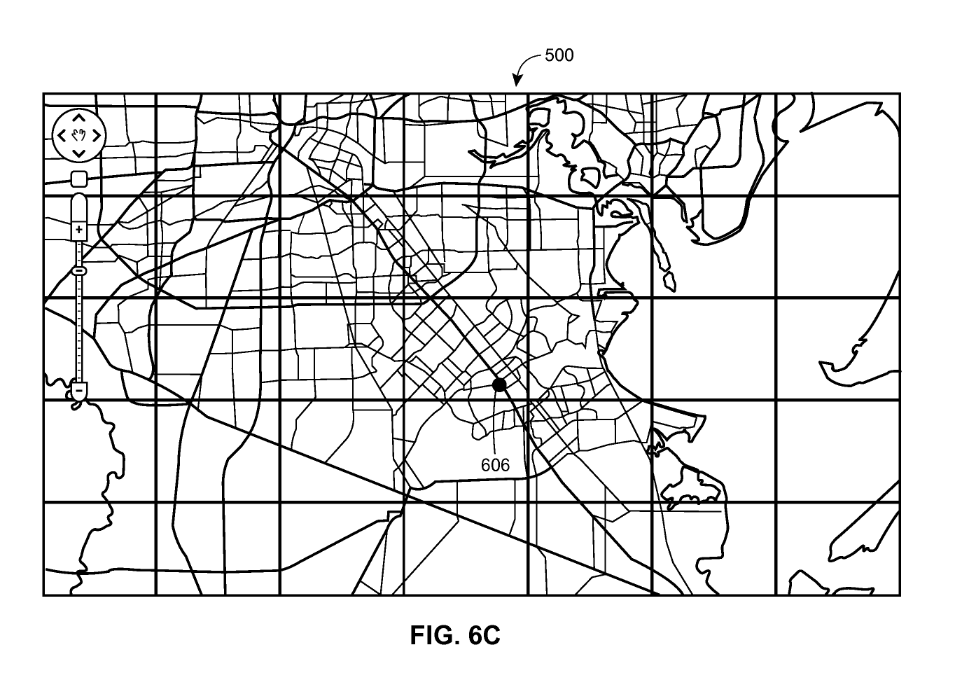

FIGS. 6A-6C illustrate the visual map displays (300, 400, and 500) of FIGS. 4A-4C, respectively, but showing map points of interest identified by the module 182. The points of interest that are displayed on the user interface 134 depending on the zoom level. FIG. 6A illustrates three points of interest 602, 604, and 606; while FIG. 6B illustrates only two points of interest 604 and 606; and FIG. 6C illustrates only one point of interest 606.

Returning to FIG. 5, at a block 704, the zoom level module 190 of the pre-fetching module 183 identifies one or more desired zoom levels for the points of interest. If the routine or process 700 is initiated by the user interacting with a mapping application, the zoom level module 190 may identify a zoom level based on the zoom level selected by the user. In other embodiments, the zoom level module 190 may identify the most recently last-used zoom level by the user or the most frequently used zoom level as the identified zoom level.

At a block 706, the database interface module 181 communicates the map points of interest (block 702) and the zoom level data (block 704) to the server 105, in particular, in the illustrated embodiment, to a pre-fetch data engine 750 at the server 105 (see, FIG. 1). The pre-fetch data engine 750 then identifies the one or more map points of interest and zoom level(s) and determines the map data corresponding to the one or more points of interest at the selected one or more zoom levels that are to be fetched from the map database 103. The engine 750 collects the corresponding map tiles and begins transmitting that map data to the map generator 120.

In the illustrated embodiment, at a block 706, the interface module 181 requests pre-fetch map data for all map points of interest, which the module may do all at one time or which the module may do one at a time. Either way, the interface module 181 may package the data from blocks 702 and 704 and send to the server a data frame having an identification header that contains, among other things, an identification field identifying the client device and a payload that identifies the one or more map points of interest and the zoom level or zoom levels for which to collect map data. The map points of interest may be identified by a longitude and latitude coordinate, in some embodiments. Optionally, in some embodiments where the block 706 requests all pre-fetch map data at once, the server 105 may send the responsive pre-fetch map data tiles in subsets, i.e., in blocks of one or more map data tiles, but not in a continuous stream. As each subset of the pre-fetch map data tiles is received, the block 706 may send a return signal, in the form of an “acknowledgment” signal, back to the server 105 to confirm receipt of the data.

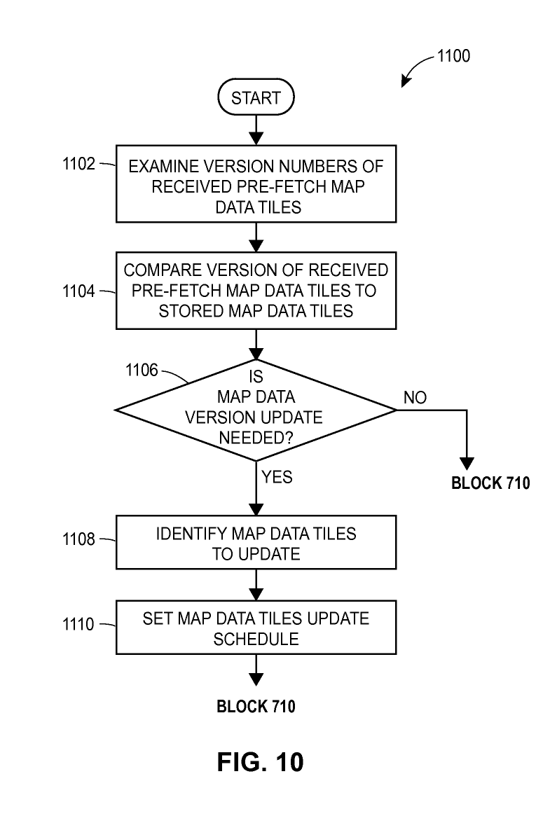

In any event, the server 105 replies to the client device 115 request by sending pre-fetching map data tiles back to interface module 181 (block 706) for subsequent processing. As the map data tiles are received, at a block 708, the version updater module 188 checks the version of the received pre-fetch map data tiles from the server 105. Example implementations of the module 188 and the block 708 are described with respect to FIG. 10.

For FIG. 5, after the version updater module 188 has determined if a version update is needed, at a block 710, the interface module 181 stores the pre-fetch map data tiles in the memory buffer 180 for subsequent display to the user.

At a block 712, the routine or process 700 determines whether all pre-fetch map data tiles have been received to the client device 115. If not, then control is passed back to block 706 to receive further map data tiles after which another version check is performed on the newly received map data tiles. If there are no further map data tiles to receive from the server, the routine or process 700 passes control to a block 713, where the client device 115 awaits some user interaction, i.e., a subsequent interaction after the pre-fetching of blocks 701-710. Once as user as performed an interaction that is to result in rendering (i.e., construction and display) of a visual map display, through a block 714, the module 186 identifies a subset of the previously-stored pre-fetch map data to display to the user on a visual display that is rendered by the display module 184 through a block 716.

The cached map data memory stored on the client device 115 can include previously downloaded (pre-fetched or otherwise) map data tiles as well as map data tiles pre-fetched by the routine or process 700, leaving some map data tiles as newer version tiles and others as older version tiles. The visual map may therefore contain map data tiles that are older, or out of date. In some examples, the block 716 will nonetheless display these older map data tiles, even before their version update has been performed, to provide the user with a more pleasing visual experience and allow for optimizing the efficiency of tile updating. Therefore, the present techniques are able to identify map data tiles that are to be updated. But the techniques do not need to update these tiles immediately, e.g., before display to the user. Rather, in some examples, older tiles may still be displayed, if needed to construct a visual map, and then scheduled for update at a later time. That later update time may occur right after display of the older tiles, thereby allowing the client device 115 to replace those older tiles with newer ones accessed while the visual map is being displayed. While, in other examples, that later update may occur at a scheduled time.

While not illustrated, in some embodiments, in additional to checking the version number, the client device 115 may perform various other data checks on the received pre-fetch map data tiles, including a tile budget check to see if the received map data tiles exceed a desired limit on the number or amount of data tiles that can be stored on the client device.

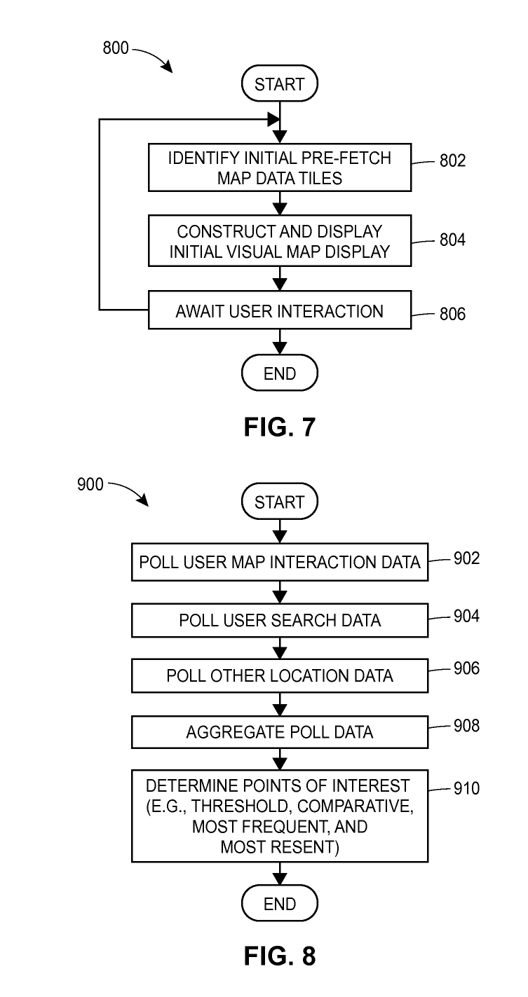

FIG. 7 illustrates a routine or process 800 that may be performed by the blocks 714-716 (display module 184), i.e., in response to a user request for map data occurring after the pre-fetch map data has been automatically collected and stored. The client device 115 maintains all received pre-fetch map data from the server 105 in the memory buffer 180. At a block 802, the map data selector module 186 identifies an initial subset of the pre-fetch map data for display. At a block 804, the display module 184 constructs and displays on the user interface 134 a visual map display of this initial subset of the pre-fetch map data, including one or more map points of interest. The initial display is provided to visualize the map points of interest. The display is an initial display in that the client device will have likely received and stored a large number of map data tiles, too many to display at any given time, irrespective of zoom level; therefore only a subset of the map data tiles are displayed at one time. At a block 806, the display module 184 detects further user interactions with the interface 134, waiting for the user to interact with the visual display of map data as the user selects different regions of the map data that are to be displayed. For example, at the block 806, the display module 184 detects a user scrolling across the displayed map data to depict adjacent map data to the initial point of interest. Such scrolling may be sideways across the display, up or down, or any other desired direction. The user may also choose to alter the map by changing zoom levels, either increasing to zoom in further on the map data or decreasing to zoom further out. The user may tilt or rotate the client device 115 to provide further user interactions. The block 806 identifies map manipulation user interaction data to the block 802, which then determines which other pre-fetched map data, stored in the buffer memory 180, is to be displayed in response to the user interaction. The visual map created at block 804 may contain up-to-date map data tiles and map data tiles bearing older version numbers. For example, initially the map may contain the most recently pre-fetched map data tiles, such as those corresponding to the points of interest identified in routine or process 700. As the user scrolls across, zooms out, tilts, etc. the block 802 may identify different map data tiles, from the map data memory, that are to be displayed. These different map data tiles may include older tiles that have not been recently updated.

At the block 806, upon appropriate instruction from the user, the routine or process 800 terminates entirely, for example, when a user selects to exit a mapping application.

FIG. 8 illustrates a routine or process 900 for automatically determining (i.e., prior to user interaction or initiation) points of interest as may be performed by block 702. The map point identifier module 182 performs a series of data polling operations, accessing data stored in the memory 132 to aggregate one or more potential points of interest. At a block 902, the module 182 polls current user interaction data or stored user map interaction data, such as data on past user interactions with map data displayed on the interface 134, including data such as locations highlighted by the user, map points placed on a map display by the user, and geographic regions most displayed on a map display, for example. At a block 904, the module 182 polls data on user searches, identifying locations the user has requested be identified on a map display. At a block 906, the module 182 polls any other location data, including current geographic position and stored geographic position. The latter includes can data such as tracking geographic position of the client device 115 to automatically determine location patterns. For example, the module 182 may collect data on client device locations during workweek, Monday-Friday, and use that data for pre-fetching map data develop travel patterns of the client device. The module 182 may collect different data to determine different typical travel patterns, and thus different potential points of interest, during the weekend. It is noted that these examples are described in terms of points of interest, but as used herein, a point of interest represents a particular point on a map or any region of a map that can be defined (specifically or even generally) by a map point.

At a block 908, the module 182 aggregates the polled potential points of interest data and provides this data to a block 910 that determines a set of one or more points of interest to be identified to the remove server 105 by the interface module 181 (block 706). The block 910 may determine the points of interest by using any number of techniques, such as a threshold determination, for example, identifying any points of interest that have been accessed by the user a certain number of times or a certain percentage of time over a given period of time. The block 910 may determine the points of interest comparatively, for example, by determining which points of interest are the most frequently accessed. The block 910 may make the determination based on which points of interest are most recently accessed.

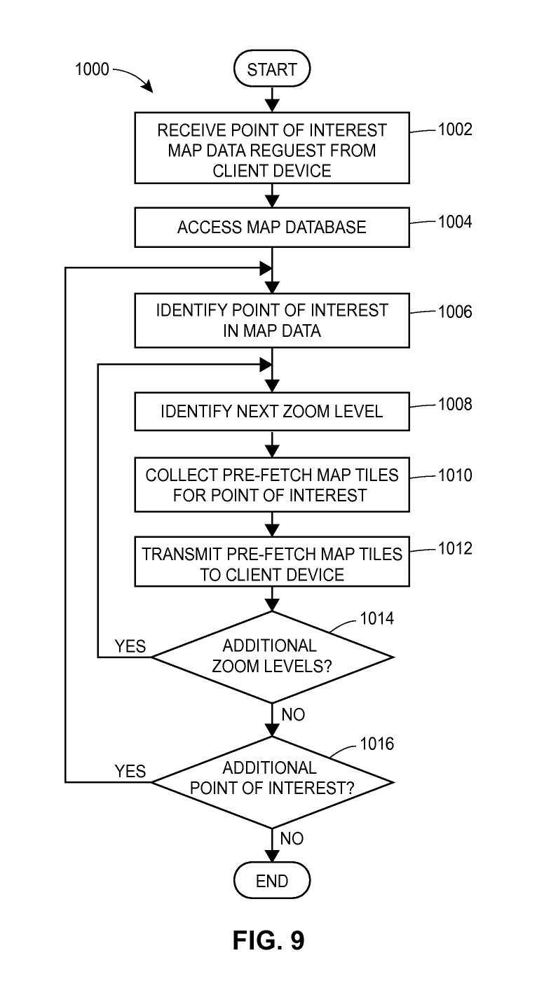

FIG. 9 illustrates an example routine or process 1000 as may be performed by the server 105, specifically the pre-fetch data engine 750, upon receipt of the identified points of interest and zoom levels at a block 1002. At a block 1004, the server 105 accesses the map database 103, and takes one of the points of interest and identifies the map data corresponding to that point of interest, at a block 1006. At a block 1008, the server 105 identifies a zoom level, e.g., from the zoom level received to block 1002, at which to collect the initial set of map data from the database 103. For the identified zoom level, a block 1010 collects a subset of all map data tiles, specifically, a subset defining the pre-fetch map data tiles associated with the point of interest. For example, with each map data tile stored in an assigned geographic position (e.g., by index value), then the block 1010 may identify a predetermined set of map data tiles adjacent the map data tile containing the point of interest. That predetermined number of adjacent map data tiles may depend on the zoom level, where at larger zoom levels, more map data tiles are identified for transmission to the client device 115. Furthermore, that predetermine number of adjacent map data tiles may depend on which map data tile contains the point of interest and where within that map data tile the point of interest is located.

At a block 1012, the server 105 transmits a subset of the identified pre-fetch map data tiles collected at block 1010 to the requesting client device 115, where the requesting client device 115 is identified by address information in a header of the data provided to block 1002. The server sends a subset of the pre-fetch map data tiles, which allows the client device 115 to frequently perform checks on the received data, such as version checks via block 708. The subset includes at least one pre-fetch map data tile; and the smaller the subset the more frequently the client device 115 will check the received data.

In the illustrated embodiment, at a block 1014, the server 105 determines if the client device has identified a need for map data stored at additional zoom levels, where if so, control is passed back to the block 1008, which identifies the next zoom level and the process repeats, as described. In some embodiments, the client device 115 (i.e., the database interface module 181 via block 706), sends requests for pre-fetch map data on a per point of interest basis, i.e., awaiting receipt of all pre-fetch map data tiles for one point of interest, before identifying the next point of interest to the server 105. In other embodiments, the client device 115 (again through block 706) requests pre-fetch map data for a plurality of map points of interest at one time. In the case of the later, if no additional zoom level data is required for the particular point of interest, then a block 1016 determines if additional points of interest have been identified by the client device, where if so, control is passed back to the block 1006 which identifies the next point of interest and the process repeats, as described. If not the routine or process 1000 ends.

FIG. 10 illustrates a routine or process 1100 that may be implemented by the block 708 (the version updater module 188). At a block 1102, the updater module 188 examines the received pre-fetch map data tile or tiles received at block 706 to determine a version number of thereof. For example, the block 1102 may strip off from a map data tile frame version number field. The updater module 188 identifies and stores the version number of each of the received pre-fetch map data tiles, along with map tile index identifier that uniquely identifies each of the map data tiles.

At a block 1104, the updater module 188 compares the version number or numbers of the received pre-fetch map data tiles against the version number or numbers of map data tiles previously stored in the map buffer memory 180. This comparison can be achieved in numerous different ways, all of which are encompassed herein. For example, in some embodiments, at the block 1104, the updater module 188 compares recently received map data tiles to stored map data tiles, on per map tile index identifier basis. In this way, the updater module 188 determines for each received map data tile whether a new version of an already stored map data tile has been received. In such examples, the block 708 requests pre-fetch map data tiles from the server 105 irrespective of whether map data tiles corresponding to the point of interest are already stored on the client device 115.

In other embodiments, instead of comparing version numbers on a per map data tile basis, at the block 1104, the updater module 188 first determines the highest version number of the received pre-fetch map data tiles and then compares that version number to those of the stored map data tiles, either to each of the stored map data tiles or to the version number of the highest version from among the stored map data tiles. This embodiment may be used when the updater module 188 looks to do whole scale version updating, for example. In this way, the version number determined from block 1102 may be compared to version numbers of any map data tile whether that tile corresponds to the same geographic area (same identification number) or not.

After the comparison, at a block 1106, the updater module 188 determines if the received pre-fetch map data tiles contain map data tiles of a higher, i.e., more recent, version number. If a more recent version has been received, at a block 1108, the updater module 188 identifies which map data tiles have an older version than the received map data tiles, specifically which map data tiles that are not to be replaced by the received map data tiles. That is, the block 1108 identifies the set of older version map data tiles. The block 1108, for example, may store a map tile index identifier value for each of these older map data tiles, buffering those in the memory 180. At a block 1110 identifies, the updater module 188 instructs the client device 115 to poll the remote server 105 for updated map data tile versions. Typically, such polling will occur after all pre-fetch map data tiles have been received through the process 700. Therefore, the block 1110 sets a scheduling scheme for the client device 115 to use in updating these older map data tiles. In some examples, the schedule set via the block 1110 is set to be dependent on characteristics of the client device 115. For example, the block 1110 may set the schedule for tile updating to occur when the client device is in an inactive mode, where the device is ON but not currently receiving data from the network 125 or only receiving below a determined threshold amount of data. In other examples, the block 1110 may set the schedule for map data tile updating when the battery power level of the device 115 is above a threshold level. The block 1108 passes control back to the process 700 after scheduling.

Back to the block 1106, if it is determined that a more recent version of map data tiles has not been received, then control is passed back to the process 700, more specifically to the block 710, which stores the received pre-fetch map data tiles.

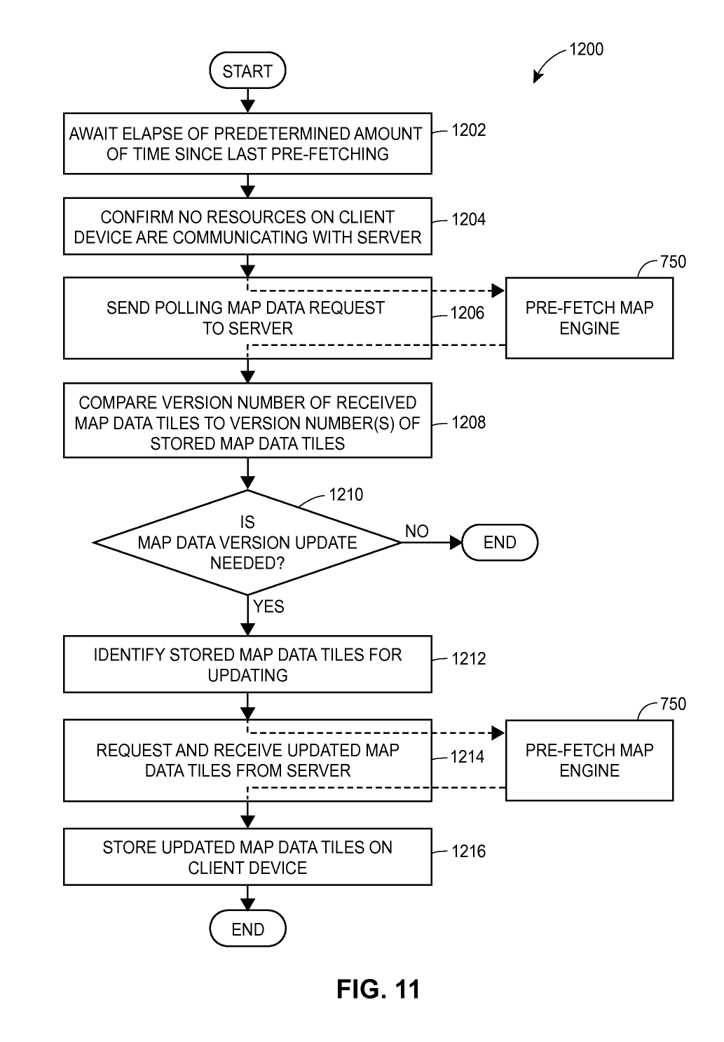

FIG. 11 illustrates a routine or process 1200 that may be used in another embodiment to determine whether updated map data tiles are stored at the server 105 separate from the routine or process 1100. This embodiment may occur in conjunction with or alternative to that of the routine or process 1100. As discussed, the process 1200 occurs in a pre-fetching manner, in that user interaction is not used to initiate the determination of whether updated tiles exist. However, in other examples, tile updating may be initiated by user interaction.

In the illustrated embodiment, the client device 115 looks to periodically poll the server 105 to determine if the newer map data tiles have been uploaded to the server 105, in which case, a determination is to be made on whether the map data tiles stored on the client device 115 should be updated. At a block 1202, the updater module 188 determines whether a predetermined amount of time has elapsed since the last pre-fetching of map data, e.g., since the last time the routine or process 700 was performed and executed. In other embodiments, the updater module 188 may be set to commence polling at specified times or specified intervals (hourly, daily, weekly, monthly, or some subset thereof).

At a block 1204, the updater module 188 optionally determines whether there are any applications actively requesting or receiving data from the network 125, in which case the block 1204 may wait for completion of the request or acquisition, as illustrated, or in which case the block 1204, in other embodiments, may instruct the block 1202 to wait an additional predetermined period of time before commencing with polling, in a recursive manner.

Once a sufficient time has passed and optionally no other resources are communicating with the server, at a block 1206, the updater module 188 polls the server 105 by sending (through the interface module 181) a polling map data request to the server 105, requesting map data. In some embodiments, the block 1206 sends a full map data tile request to the server 105, for example, by requesting a map data tile having an index identifier that corresponds to the index identifier of at least one map data tile already stored in the map memory buffer 180. When requesting a map data tile, the block 1206 sends to the server 105, via the network 125, a request in a data frame that identifies the client device 115, by index identifier number, and identifies the desired map data tile, by index identifier number. The server 105, for example, the pre-fetch engine 705, identifies the appropriate response map data tile from the map database 103 and transmits the same back to the client device 115 (through interface module 181).

At a block 1208, the updater module 188 examines the version number of the received map data tile and compares the version number of the received map data tile to the version number of the corresponding map data tile already stored in the map buffer memory 180. At a block 1210, the updater module 188 determines if a newer version of the map data is stored at the server 105, in which case control is passed to a block 1212, otherwise the process 1200 ends. If it is determined, that a newer version exists, then at a block 1212, the updater module 188 identifies all stored map data tiles, by index identifier number, that are in need of updating, i.e., that have a version number older than the version number of the received map data tile. Therefore, at the block 1212, the version updater module 188 will identify from among the client-device stored pre-fetch and/or regular fetch map data tiles which of these stored map data tiles are to be updated to a newer version. Therefore, in the illustrated embodiment, not all higher version map data tiles will be downloaded from the map database 103, instead those corresponding to the already stored map data tiles.

It is noted that depending on the which map data tiles are identified in the polling request of block 1206, a version update may not be identified, when the map database 103 does store other map data tiles are bear updated versions in comparison to their counterpart map data tiles. Therefore, the block 1206 may identify a plurality of map data tiles in the map data request. Furthermore, those map data tiles may be chosen to cover a selected subset of the map data tiles stored in the map database 103. First, the block 1206 will identify map data tiles within the region of the currently stored map data tiles on the client device 115. Second, the block 1206 will, in some examples, request map data tiles corresponding to a selected portion of those stored map data tiles, i.e., a portion corresponding to a selected pattern of map data.

At a block 1214, the interface module 181 (through the interface module 181) sends the resulting map data tile data to the server 105 as a request for map data tiles. The server 105, i.e., the pre-fetch engine 750, identifies all corresponding map data tiles stored in the map database 103, which typically would include only a subset of the stored map data (i.e., corresponding to a pre-fetch map data tiles). The server 105 transmits the newer map data tiles to the client device 115, which at a block 1216 stores them over the previously stored, and older version map data tiles in the map buffer memory 180.

The routine or process 1200 may be executed for map data tiles at a single zoom level, at a time. For example, through the block 1202, the version updater module 188 may check for updated map data tiles of different zoom levels at different times, which may be more useful for systems in which the map data at different zoom levels is more likely to contain different version numbers. Updating map data for each zoom level at different times may also be more useful when the most frequent map data updates occur at higher zoom levels, meaning fewer updates at lower zoom levels. Therefore, in some embodiments the routine or process 1200 is performed at different times for different zoom levels based on the zoom-level specific event trigger of block 1202.

In other examples, the routine or process 1200 is executed once from which the version updater module 188 is able to schedule updates for all zoom levels. In such examples, the polling map data requests from block 1206 may identify map data tiles at each over the zoom levels having corresponding map data tiles already stored in the client device. For example, if pre-fetch map data tiles for 5 zoom levels are stored in the client device 115, then the block 1206 may determine polling map data tiles at each of these zoom levels, i.e., by tile identification number and zoom number, and send polling requests to the server 105 for sending the corresponding map data tiles stored in the map database 103. The comparison performed at the block 1208 may then be performed on a zoom level basis, while the blocks 1210 and 1212 may examine and identify map data tiles in need of updating at each of the zoom levels. The result may be that not all of the zoom levels will need updating.

It is noted that while the foregoing is described in which the pre-fetch map engine 750 responds to the polling request by providing the map data tile, in other examples of the routine or process 1200, the engine 750 responds by identifying only the version number for the corresponding map data tiles identified in the polling request.

Further still, with the illustrated example, the determination of whether a version update is needed is based on the map data tiles identified in a polling request. As such the block 1206 may identify not only map data tiles corresponding to the map data tiles already stored in the client device, but the block 1206 may identify map data tiles across a predetermined region of these stored map data tiles. For example, if the number of stored map data tiles at each zoom level approximately represents an N×M matrix of map data tiles, then the polling request from block 1206 may request updates to map data tiles in every other column or every other row of this matrix. The block 1206 may request map data tiles over the diagonals of the matrix, i.e., from (1,1) to (N,M) and from (N,1) to (1,M). The block 1206 may request any subset of the stored map data tiles. In yet other examples, the block 1206 may poll for updates for all stored map data tiles in one or more zoom levels.

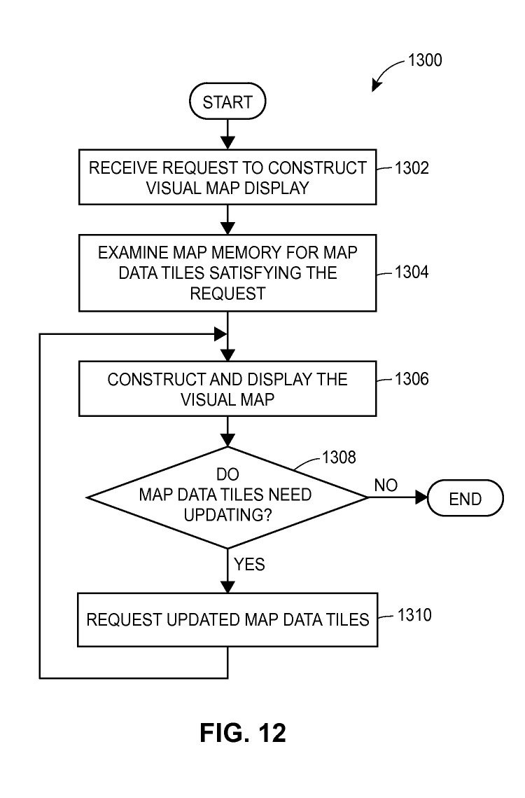

FIG. 12 illustrates a routine or process 1300 in accordance with an example version tile update that may occur in a non-pre-fetch environment. At a block 1302, a request is received to construct a visual map and display that visual map on the client device 115. That request may be received to the map data selection module 186, for example. At a block 1304, the module 186 examines the map memory buffer 180 for the map data tiles necessary to construct the visual map display. At a block 1306, the visual map display is constructed and displayed, either only or partially, from the identified map data tiles. During or after the display of the visual map, at a block 1308, the map generator 120 determines if updated versions of the map data tiles are available. For example, the map generator 120 may perform an operation like that of the routine or process 700 polling the remote server 105 to determine if updated map data tiles exist, e.g., by identifying points of interest and zoom levels to the remote server 105. If updated map data tiles exist, then at a block 1310, the map generator requests those updated map data tiles and control is passed back to the block 1306, where the map data selection module 186 stores the updated map data tiles and the display module 184 displays them, replacing any currently displayed older map data tiles, with the newly updated map data tiles. In this way, the user is presented with the visual map immediately and the client device 115 is able to update displayed map data tiles without the user knowing or without delaying the display of map data.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 125 may include but is not limited to any combination of a LAN, a MAN, a WAN, a mobile, a wired or wireless network, a private network, or a virtual private network. Moreover, while only three clients 115 are illustrated in FIG. 1 to simplify and clarify the description, it is understood that any number of client computers are supported and can be in communication with the server 105.

Additionally, certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map editor system for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method comprising:
identifying, on a client device, one or more map points of interest by predicting in advance of a user request one or more distinct geographic locations for which a user is likely to request map data;
identifying, based on the map points of interest, a plurality of pre-fetch map data tiles to be requested from a remote map database and stored on the client device for eventual rendering of a visual display of map data in response to a subsequent user request, wherein the plurality of pre-fetch map data tiles graphically represent the identified one or more map points of interest at a plurality of zoom levels, and each of the plurality of pre-fetch map data tiles includes a map data version number;
requesting, from a remote map database storing the map data, the plurality of pre-fetch map data tiles corresponding to the one or more map points of interest without receiving further communication from the user;
receiving, at the client device, the pre-fetch map data tiles from the remote map database;
determining, at the client device, that one or more of the received pre-fetch map data tiles has a newer map data version number than a map data version number for one or more other map data tiles stored on the client device;
scheduling a map data tile version update for each of the one or more other map data tiles stored on the client device that includes an older map data version number than the newer map version number of the one or more received pre-fetch map data tiles; and
storing the received pre-fetch map data tiles in a local memory on the client device.

2. The method of claim 1, wherein determining if any of the received pre-fetch map data tiles has a map data version number newer than a map data version number for map data tiles stored on the client device further comprises:
determining a version number of one of the received pre-fetch map data tiles; and
comparing the version number of the one of the received pre-fetch map data tiles to a version number for a corresponding stored map data tile.

3. The method of claim 1, wherein determining if any of the received pre-fetch map data tiles has a map data version number newer than a map data version number for map data tiles stored on the client device further comprises:
determining a version number for each of the received pre-fetch map data tiles; and
for each of the received pre-fetch map data tiles, comparing the version number to a version number of a stored map data tile having a corresponding map tile index identifier value.

4. The method of claim 1, wherein determining if any of the received pre-fetch map data tiles has a map data version number newer than a map data version number for map data tiles stored on the client device further comprises:
determining a highest version number for the received pre-fetch map data tiles; and
comparing the highest version number to a version number for each of a set of stored map data tiles.

5. The method of claim 1, wherein determining if any of the received pre-fetch map data tiles has a map data version number newer than a map data version number for map data tiles stored on the client device further comprises:
determining a highest version number for the received pre-fetch map data tiles; and
comparing the highest version number to a highest version number among a predetermined set of stored map data tiles.

6. The method of claim 1, wherein determining if any of the received pre-fetch map data tiles has a map data version number newer than a map data version number for map data tiles stored on the client device further comprises:
determining a highest version number for the received pre-fetch map data tiles; and
comparing the highest version number to a highest version number among all stored map data tiles.

7. The method of claim 1, where if the map data tile version update is to be scheduled, further comprising:
identifying map data tiles to be updated; and
scheduling the map data tile version update.

8. The method of claim 1, further comprising:
identifying, from the plurality of zoom levels, one or more zoom levels, such that the pre-fetch map data tiles are identified based on the one or more map points of interest and the identified one or more zoom levels.

9. The method of claim 8, wherein the remote map database stores map data at different zoom levels, each zoom level containing a respective set of map data tiles.

10. A non-transitory computer-readable medium storing instructions, the instructions when executed by a processor cause the processor to:
identify, on a client device, one or more map points of interest by predicting in advance of a user request one or more distinct geographic locations for which a user is likely to request map data;
identify, based on the map points of interest, a plurality of pre-fetch map data tiles to be requested from a remote map database and stored on the client device for eventual rendering of a visual display of map data in response to a subsequent user request, wherein the plurality of pre-fetch map data tiles graphically represent the identified one or more map points of interest at a plurality of zoom levels, and each of the plurality of pre-fetch map data tiles includes a map data version number;
request, from a remote map database storing the map data, the plurality of pre-fetch map data tiles corresponding to the one or more map points of interest without receiving further communication from the user;
receive, at the client device, the pre-fetch map data tiles from the remote map database;
determine, at the client device, that one or more of the received pre-fetch map data tiles has a newer map data version number than a map data version number for one or more other map data tiles stored on the client device;
schedule a map data tile version update for each of the one or more other map data tiles stored on the client device that includes an older map data version number than the newer map version number of the one or more received pre-fetch map data tiles; and
store the received pre-fetch map data tiles in a local memory on the client device.

11. The non-transitory computer-readable medium storing instructions of claim 10, having further instructions that, when executed, cause the processor to:
determine a version number of one of the received pre-fetch map data tiles; and
compare the version number of the one of the received pre-fetch map data tiles to a version number for a corresponding stored map data tile.

12. The non-transitory computer-readable medium storing instructions of claim 10, having further instructions that, when executed, cause the processor to:
determine a version number for each of the received pre-fetch map data tiles; and
for each of the received pre-fetch map data tiles, compare the version number to a version number of a stored map data tile having a corresponding map tile index identifier value.

13. The non-transitory computer-readable medium storing instructions of claim 10, having further instructions that, when executed, cause the processor to:
determine a highest version number for the received pre-fetch map data tiles; and
compare the highest version number to a version number for each of a set of stored map data tiles.

14. The non-transitory computer-readable medium storing instructions of claim 10, having further instructions that, when executed, cause the processor to:
determine a highest version number for the received pre-fetch map data tiles; and
compare the highest version number to a highest version number among a predetermined set of stored map data tiles.

15. The non-transitory computer-readable medium storing instructions of claim 10, having further instructions that, when executed, cause the processor to:
determine a highest version number for the received pre-fetch map data tiles; and
compare the highest version number to a highest version number among all stored map data tiles.

16. The non-transitory computer-readable medium storing instructions of claim 10, having further instructions that, when executed, cause the processor to:
if the map data tile version update is to be scheduled,
identify map data tiles to be updated, and
schedule the map data tile version update.

17. The non-transitory computer-readable medium storing instructions of claim 10, having further instructions that, when executed, cause the processor to:
identify, from the plurality of zoom levels, one or more zoom levels, such that the pre-fetch map data tiles are identified based on the one or more map points of interest and the identified one or more zoom levels.

18. The non-transitory computer-readable medium storing instructions of claim 10, wherein the remote map database stores map data at different zoom levels, each zoom level containing a respective set of map data tiles.

19. A computer system for fetching map tile data to be used in rendering a visual display of map data on a client device, the computer system comprising:
a processor; and
a memory storing a plurality of modules including instructions for execution on the processor, the modules including:
a display module including instructions executed on the processor to render the visual display of the map data, where the map data is stored in a remote map database as a plurality of map data tiles;
a map point identifier module including instructions executed on the processor to identify one or more map points of interest by predicting in advance of a user request one or more distinct geographic locations for which a user is likely to request map data, which map points of interest define a plurality of pre-fetch map data tiles to be requested from a remote map database and stored on the client device for eventual rendering of a visual display of map data in response to a subsequent user request, wherein the plurality of pre-fetch map data tiles graphically represent the identified one or more map points of interest at a plurality of zoom levels, and each of the plurality of pre-fetch map data tiles includes a map data version number;
a database interface module including instructions executed on the processor to request from the map database, the plurality of pre-fetch map data tiles from the remote map database and that receives the pre-fetch map data tiles from the remote map database without receiving further communication from the user; and
a map tile version updater module including instructions executed on the processor to, in response to receiving the pre-fetch map data tiles:
determine at the client device, that one or more of the received pre-fetch map data tiles has a newer map data version number than a map data version number for one or more other map data tiles stored on the client device, and
schedule a map data tile version update for each of the one or more other map data tiles stored on the client device that includes an older map data version number than the newer map version number of the one or more received pre-fetch map data tiles.

20. The computer system of claim 19, wherein the map tile version updater module further includes instructions executed on the processor to:
determine a version number of one of the received pre-fetch map data tiles; and
compare the version number of the one of the received pre-fetch map data tiles to a version number for a corresponding stored map data tile.

21. The computer system of claim 19, wherein the map tile version updater module further includes instructions executed on the processor to:
determine a version number for each of the received pre-fetch map data tiles; and
for each of the received subset of the pre-fetch map data tiles, compare the version number to a version number of a stored map data tile having a corresponding map tile index identifier value.

22. The computer system of claim 19,
wherein the map tile version updater module further includes instructions executed on the processor to:
determine a highest version number for the received pre-fetch map data tiles; and
compare the highest version number to a version number for each of a set of stored map data tiles.

23. The computer system of claim 19, wherein the map tile version updater module further includes instructions executed on the processor to:
determine a highest version number for the received pre-fetch map data tiles; and
compare the highest version number to a highest version number among a predetermined set of stored map data tiles.

24. The computer system of claim 19, wherein the map tile version updater module further includes instructions executed on the processor to:
determine a highest version number for the received pre-fetch map data tiles; and
compare the highest version number to a highest version number among all stored map data tiles.

25. The computer system of claim 19, wherein the map tile version updater module further includes instructions executed on the processor to:
identify map data tiles to be updated; and
schedule the map data tile version update.

26. The computer system of claim 19, further comprising:
a zoom level module including instructions executed on the processor to identify, from the plurality of zoom levels, one or more zoom levels, such that the pre-fetch map data tiles are defined based on the one or more map points of interest and the identified one or more zoom levels, and wherein the remote map database stores map data at different zoom levels, each zoom level containing a respective set of map data tiles.

27. The computer system of claim 26, wherein the map data at each zoom level is stored in map data tiles of identical memory allocation size.

28. The computer system of claim 19, wherein the database interface module includes further instructions executed on the processor to await a user interaction with the client device before executing one or more instructions to identify a subset of the pre-fetch map data tiles stored on the client device and executing one or more instruction to render the visual display using the subset of the pre-fetch map data tiles.

29-43. (canceled)
